(19) United States
(12) Patent Application Publication
(10) Pub. No.: US 2010/0250702 A1
(43) Pub. Date: Sep. 30, 2010

(54) DIGITAL CONTENT PROCESSING SYSTEM AND METHOD

(75) Inventors: Ho-Chung Wang, Taipei (TW); Ying-Tsung Lee, Taipei (TW); Ying-Lung Li, Taipei (TW); Wei-Wei Tseng, Taipei (TW); Ling-Yueh Chang, Taipei (TW); Meng-Kai Tsai, Taipei (TW); Yu-Ling Chuang, Taipei (TW)

Correspondence Address: PEARNE & GORDON LLP, 1801 EAST 9TH STREET, SUITE 1200, CLEVELAND, OH, 44114-3108, US

(73) Assignee: CHUNGHWA TELECOM CO., LTD., Taipei (TW)

(21) Appl. No.: 12/615,493

(22) Filed: Nov. 10, 2009

(30) Foreign Application Priority Data
Mar. 31, 2009 (TW) 098110596

(51) Int. Cl. G06F 15/16

(52) U.S. Cl. 709/217; 709/229

(57) ABSTRACT

A digital content processing system and a digital content processing method are disclosed. The method includes the steps of: setting identification data and transmission authority of a data access device in the digital content processing system; authenticating the data access device by the digital content processing system according to the identification data when the digital content processing system receives a connection request of the data access device through the communication network; and enabling the data access device to, under control of the digital content processing system, download digital content and/or upload digital content of the data access device according to the transmission authority of the data access device if the data access device passes the authentication. Therefore, with the data access device, a user unfamiliar with operation of computers and/or networks is able to share or receive digital content conveniently.

### BACKGROUND OF THE INVENTION

1. Field of the Invention

The present invention relates to digital content processing systems and methods, and more particularly, to a digital content processing system and method configured for sharing of digital content over a communication network.

2. Description of Related Art

Due to the progress of network technologies and the convenience of networks, people nowadays are increasingly dependent on networks, as people carry out many of their activities over networks. For example, people can shop over networks, and find needed information without having to go out. Moreover, people worldwide can chat and communicate with each other and instantaneously share data items such as photos with distant friends and relatives without the hassle of printing such items and sending them by regular mail. Therefore, such networks overcome time and space limitations and facilitate people's lives.

Instantaneous sharing of photos over networks is magic to many people but tragic to some. For example, the elderly unfamiliar with or even ignorant of computer networks do not benefit from advances in network technologies; instead, the elderly are likely to feel “left out of the loop” or estranged from younger relatives when the latter who are accustomed to networks enjoy sharing photos over the networks.

### SUMMARY OF THE INVENTION

According to the above drawbacks of the prior art, the present invention provides a digital content processing system and method so as to facilitate the sharing of digital content.

In order to achieve the above and other objectives, the present invention provides a digital content processing system and method. Therein, at least a data access device can be connected to the digital content processing system through a communication network so as to access digital content. The digital content processing system comprises: a setting module for setting identification data and transmission authority of the data access device; an authentication module for authenticating the data access device according to the identification data of the setting module after the data access device sends a connection request through the communication network; and a processing module for enabling the data access device to download digital content and/or upload digital content of the data access device according to the transmission authority of the data access device if the data access device passes the authentication of the authentication module.

In another embodiment, the digital content processing system further comprises an editing module for editing a web page operation interface corresponding to the identification data of the data access device, wherein, after the data access device passes the authentication of the authentication module, the processing module provides the web page operation interface to the data access device such that a user of the data access device can freely choose a digital content accessing method according to options provided by the web page operation interface. Further, if there is a plurality of data access devices, the editing module is used to edit digital content transmission paths between the plurality of data access devices and provide information about digital content sharing members on the web page operation interface, in which the digital content sharing members are the data access devices or digital content supplier that establish digital content sharing relationships with the data access device that passes the authentication, wherein, through the web page operation interface, a user can determine a destination for the digital content upload or a source for the digital content download according to the digital content sharing information.

In another embodiment, the digital content processing system further comprises a notification module, wherein, when the data access device that passes the authentication completes the digital content upload, the notification module sends an instant message to notify the receiver of the digital content, or, when the data access device that passes the authentication completes the digital content download, the notification module sends an instant message to notify the supplier of the digital content.

The digital content processing method of the present invention allows at least a data access device to connect to a digital content processing system through a communication network so as to access digital content. The digital content processing method comprises the following steps: (1) setting identification data and transmission authority of the data access device in the digital content processing system; (2) authenticating the data access device by the digital content processing system according to the identification data when the digital content processing system receives a connection request of the data access device through the communication network; and (3) enabling the data access device to, under control of the digital content processing system, download digital content and/or upload digital content of the data access device according to the transmission authority of the data access device if the data access device passes the authentication.

According to another embodiment of the digital content processing method of the present invention, the step (1) further comprises storing a web page operation interface corresponding to the identification data of the data access device such that, after the data access device passes the authentication, the digital content processing system provides the web page operation interface to the data access device, thereby allowing a user of the data access device to freely choose a digital content accessing method according to options provided by the web page operation interface. Further, if there is a plurality of data access devices, the step (1) further comprises editing digital content transmission paths between the plurality of data access devices and providing information about digital content sharing members on the web page operation interface, in which the digital content sharing members are the data access devices or digital content supplier that establish digital content sharing relationships with the data access devices that pass the authentication, wherein, through the web page operation interface, a user can determine a destination for the digital content upload or a source for the digital content download according to the digital content sharing information.

According to another embodiment, the digital content processing method of the present invention further comprises sending an instant message by the digital content processing system to notify a receiver of the digital content when the data access device that passes the authentication completes the digital content upload, or sending an instant message by the digital content processing system to notify the supplier of the digital content when the data access device that passes the authentication completes the digital content download.

Therefore, the digital content processing system and method of the present invention is characterized in that, with a data access device, a user unfamiliar with the operation of computers or networks can conveniently obtain digital content of a digital content supplier or digital content of another data access device that establishes a digital content sharing relationship with said data access device, or transmit digital content to the digital content supplier or said another data access device.

Further, the digital content processing system and method of the present invention can send an instant message to the provider or receiver of the digital content after transmission of the digital content is completed, thereby ensuring instantaneous sharing of the digital content. For example, if a user transmits a movie to a relative for celebrating the relative's birthday, after the transmission, the present invention can instantaneously notify the relative such that the relative can now watch the movie.

### BRIEF DESCRIPTION OF DRAWINGS

FIG. 1A is a schematic view of an application structure of a digital content processing system according to the present invention;

FIG. 1B is a schematic view of another application structure of the digital content processing system, wherein a plurality of data access devices having a digital content sharing relationship therebetween is provided;

FIG. 2A is a schematic view of the internal structure of the digital content processing system;

FIG. 2B is a schematic view of the internal structure of the digital content processing system according to another embodiment of the present invention;

FIG. 3 is a flow diagram of a digital content processing method according to the present invention; and

FIG. 4 is a flow diagram of the digital content processing method applied to a plurality of data access devices having a digital content sharing relationship therebetween.

### DETAILED DESCRIPTION OF PREFERRED EMBODIMENTS

The following illustrative embodiments are provided to illustrate the disclosure of the present invention. These and other advantages and effects will be apparent to those skilled in the art after reading the disclosure of this specification.

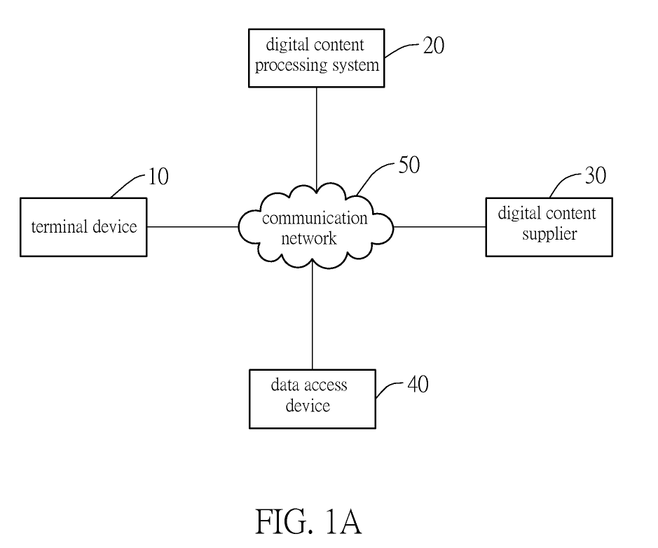

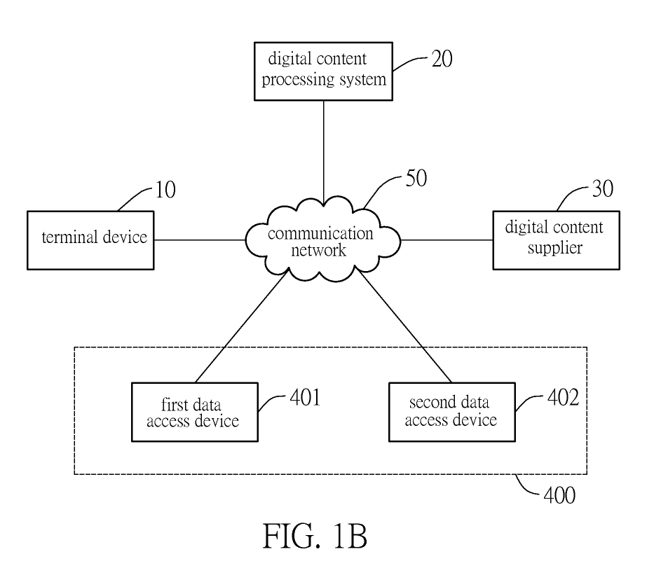

Referring to FIG. 1A, there is shown a schematic view of an application structure of a digital content processing system according to the present invention. In an embodiment, the digital content processing system 20 comprises a terminal device 10, a digital content supplier 30, a data access device 40, and a communication network 50. The terminal device 10 is an Internet-connected device and is connectable to the communication network 50. Examples of the terminal device 10 are a personal computer, a mobile phone, a notebook computer, and a personal digital assistant. In this embodiment, the communication network 50 is a wide area network, a local area network or a metropolitan area network, but is not limited thereto. The digital content supplier 30 is a service platform that allows web browsers to access digital content. In this embodiment, the digital content comprises photos or video content, and the digital content supplier 30 is a network service platform for sharing photos and videos. The data access device 40 is an Internet-connected user device applicable to the communication network 50, such as a digital photo frame, a personal computer, a mobile phone, a notebook computer, a personal digital assistant or a set top box.

In a preferred embodiment, a user at the terminal device 10 sets identification data and a transmission path of the data access device 40 in the digital content processing system 20. Thereby, the data access device 40 is connected to the digital content processing system 20 through the communication network 50 so as to obtain a web page operation interface corresponding to the identification data. Through simple operation on the web page operation interface, a user of the data access device 40 can easily share digital content thereof with others or receive the digital content of others. When the data access device 40 is connected to the digital content processing system 20 through the communication network 50, the digital content processing system 20 can identify the data access device 40 through the preset identification data and automatically transmit the digital content of the digital content supplier 30 to the data access device 40 according to the preset transmission path, or automatically transmit the digital content stored in the data access device 40 to the digital content supplier 30 through the preset transmission path.

In another preferred embodiment, the digital content processing system 20 and the digital content supplier 30 can be integrated as a single system (not shown). It should be noted that the number of data access devices 40 is not limited to that disclosed in FIG. 1A. Further, the digital content supplier 30 is not limited to the above-described network service platform for sharing photos and videos. Alternatively, the digital content supplier 30 can be any other network device capable of supplying digital content. For example, the digital content supplier 30 can be another data access device.

Referring to FIG. 1B, there is shown a schematic view of another application structure of the digital content processing system according to the present invention. The difference from FIG. 1A is that a plurality of data access devices is provided in FIG. 1B, and a digital content sharing relationship 400 is established between the data access devices. In a preferred embodiment, the terminal device 10 is connected to the digital content processing system 20 through the communication network 50, and the user of the terminal device 10 sets identification data of a first data access device 401 and a second data access device 402 in the digital content processing system 20 as well as a transmission path between the first data access device 401 and the second data access device 402 to thereby establish a digital content sharing function between the first data access device 401 and the second data access device 402. When the first data access device 401 is connected to the digital content processing system 20 through the communication network 50, the user can choose the second data access device 402 as a digital content sharing member on the web page operation interface such that the first data access device 401 can share the digital content thereof with the second data access device 402.

In another preferred embodiment, users of the first data access device 401 and the second data access device 402 can choose digital content transmission paths on the web page operation interface such that the first data access device 401 and the second data access device 402 can transmit the digital content thereof to the digital content supplier 30.

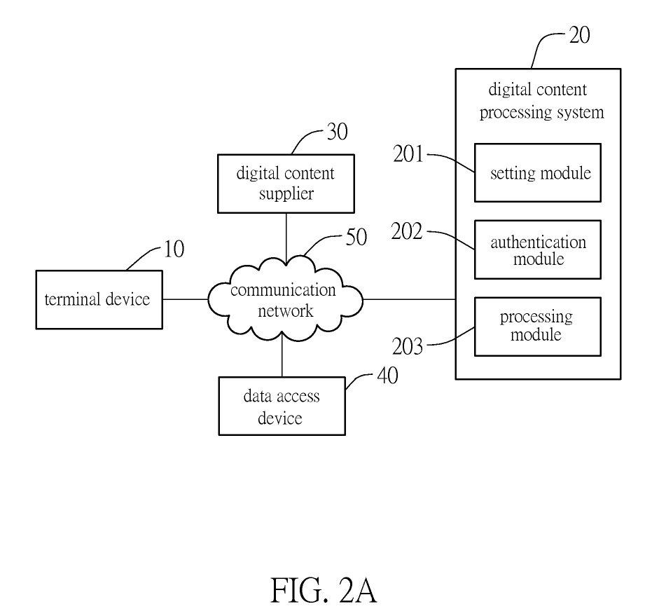

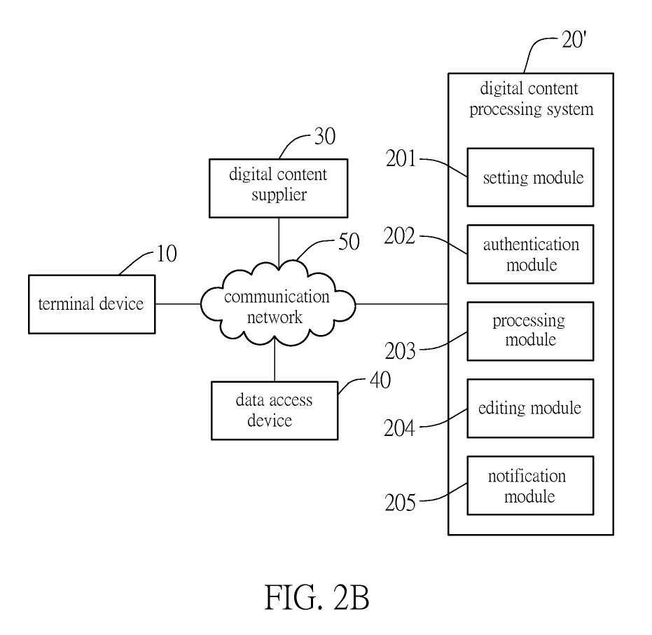

Referring to FIG. 2A, there is shown a schematic view of the internal structure of the digital content processing system 20 according to the present invention. As shown in the drawing, the digital content processing system 20 comprises a setting module 201, an authentication module 202, and a processing module 203.

The setting module 201 is used to set identification data of the data access device 40 and transmission authority of the data access device 40 relative to the digital content supplier 30. The identification data comprises a product serial number of the data access device 40, for example. The transmission authority is an upload path for the data access device 40 to perform digital content upload or a download path for the data access device 40 to perform digital content download. In general, the identification data and transmission authority are preset by a user via the terminal device 10, and the user may be, for example, the owner of the data access device 40, a relative of the owner, a seller of the data access device 40, or a professional in the network computer technology. Thereby, when the data access device 40 is to be connected to the digital content processing system 20 through the communication network 50, the digital content processing system 20 authenticates the data access device 40 according to the identification data and provides the corresponding transmission authority to the data access device 40.

The authentication module 202 is used to authenticate the data access device 40 that has sent a connection request through the communication network 50. As described above, when the data access device 40 is to be connected to the digital content processing system 20 through the communication network 50, the digital content processing system 20 authenticates the data access device 40 according to the preset identification data.

The processing module 203 is used to establish a digital content transmission path between the data access device 40 that passes the authentication and the digital content supplier 30 such that digital content can be transmitted between the data access device 40 and the digital content supplier 30. For example, according to the transmission path, the digital content is automatically captured from the digital content supplier 30 and transmitted to the data access device 40, or the digital content stored in the data access device 40 is automatically transmitted to the digital content supplier 30.

Therefore, with a digital content processing system of the present invention, a user of the data access device can easily complete the sharing of digital content by simple operation.

Referring to FIG. 2B, there is shown a schematic view of the internal structure of the digital content processing system according to another embodiment of the present invention. The difference from FIG. 2A is that the digital content processing system 20′ further comprises an editing module 204 and a notification module 205.

The editing module 204 provides a web page operation interface for the data access device 40 whose identification data and transmission authority have been preset and enables the web page operation interface to be edited so as to meet the demands of the user of the data access device 40. Therefore, after the authentication module 202 authenticates the data access device 40 that has sent a connection request through the communication network 50 and the data access device 40 passes the authentication, the editing module 204 provides a corresponding web page operation interface to the data access device 40 according to the preset identification data, such that the web page operation interface renders it easy for the user of the data access device 40 to operate the digital content processing system 20 of the present invention.

The notification module 205 is used to send an instant message to the receiver of the digital content, that is, the notification module 205 sends an instant message to the data access device 40 when the digital content processing system 20 automatically transmits the digital content of the digital content supplier 30 to the data access device 40 (the receiver of digital content), or when the digital content processing system 20 automatically transmits the digital content stored in the data access device 40 to the digital content supplier 30 (the receiver of digital content), thereby notifying the receiver of the existence of the digital content. The notification module 205 can also send an instant message to notify the supplier of the digital content that the digital content of the supplier have been voluntarily downloaded by others. In the present embodiment, the instant message is an e-mail, a newsletter, a Yahoo/MSN instant message, and so on.

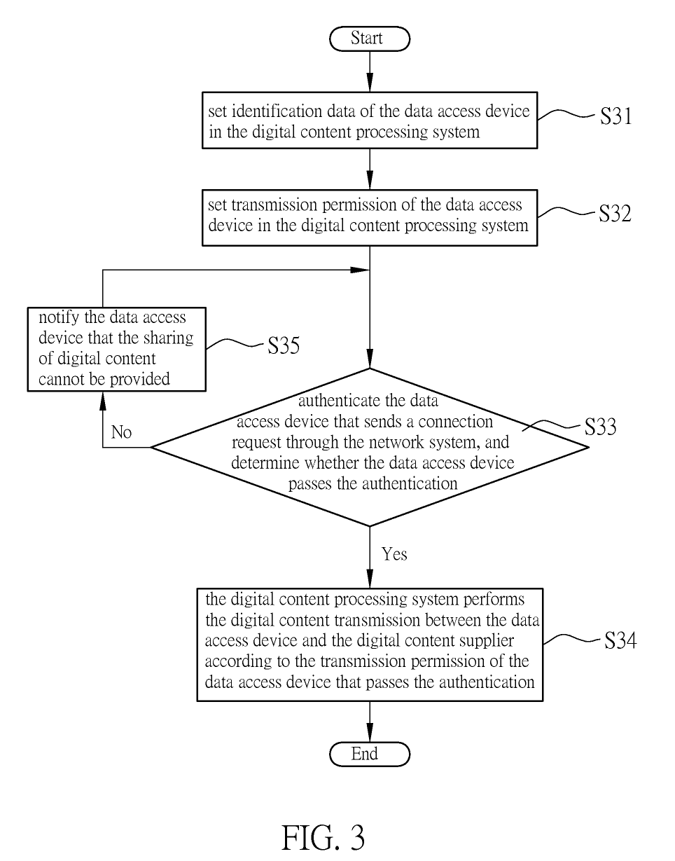

Referring to FIG. 3, there is shown a flow diagram of a digital content processing method according to the present invention. Therein, the terminal device is connected to the digital content processing system through the communication network, and the user at the terminal device logs in to the digital content processing system to perform setting so as to achieve digital content sharing between the digital content supplier and the data access device.

First, in step S31, the user at the terminal device sets identification data of the data access device through the setting module of the digital content processing system. In a preferred embodiment, the user enters the identification data related to the data access device to the setting module, wherein the identification data is the product serial number of the data access device, but is not limited thereto. Alternatively, the identification data can be a MAC (Medium Access Control) address or a customer identification code provided by an ISP (Internet Service Provider). Then, the process goes to step S32.

In step S32, the user at the terminal device sets the transmission authority of the data access device through the setting module. In a preferred embodiment, the user sets the transmission authority of the data access device corresponding to the identification data through the setting module. The transmission authority is the digital content transmission path between the data access device and the digital content supplier in terms of mapping the addresses of content suppliers and receivers together, wherein the digital content is digital information that can be transmitted through a network, such as digital photos or video information. Then, the process goes to step S33.

In step S33, the data access device that has sent a connection request through the network system is authenticated, wherein, if the data access device passes the authentication, the process goes to step S34; otherwise, the process goes to step S35. In a preferred embodiment, when the data access device is connected to the digital content processing system through the communication network, the authentication module compares the identification data of the data access device with the identification data set by the setting module.

In step S34, the digital content processing system performs the digital content transmission between the data access device and the digital content supplier according to the transmission authority of the data access device that passes the authentication. In a preferred embodiment, the data access device (that is, an Internet-connected device, such as a digital photo frame, a personal computer, a mobile phone, a notebook computer, a personal digital assistant or a set top box) that passes the authentication downloads digital content (that is, information for use in a network, such as digital photos or video information) from the digital content supplier (i.e., a network service platform, such as a digital photo album or a video blog) and/or upload the digital content thereof to the digital content supplier.

In step S35, the digital content processing system notifies the data access device that does not pass the authentication that the sharing of digital content cannot be provided.

Further, according to another embodiment of the digital content processing method of the present invention, after the data access device downloads the digital content of the digital content supplier, the digital content processing system sends an instant message to the digital content supplier so as to notify the digital content supplier that the digital content thereof has been downloaded by others. After the data access device uploads the digital content thereof to the digital content supplier, the digital content processing system sends a message to a receiver of the digital content so as to notify the receiver of the digital content that others have provided the digital content to be shared with the digital content receiver.

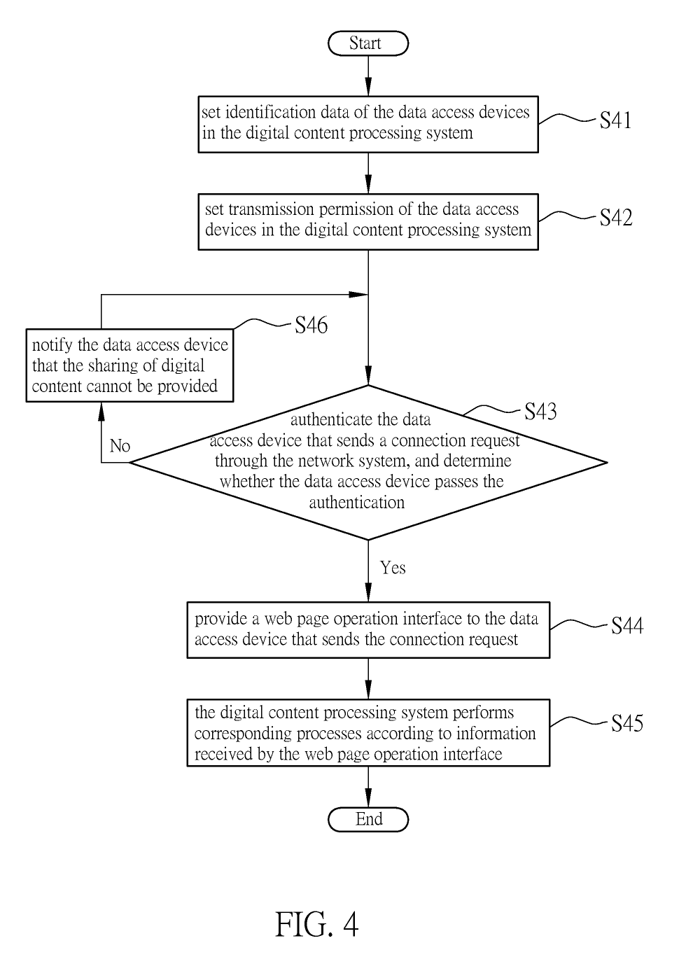

Referring to FIG. 4, there is shown a flow diagram of the digital content processing method applicable to a plurality of data access devices so as to achieve digital content sharing between the data access devices.

First, in step S41, the user at the terminal device sets identification data of the plurality of data access devices through the digital content processing system and a digital content sharing function is established between the plurality of data access devices. In a preferred embodiment, the user enters the identification data of the data access devices to the setting module of the digital content processing system. The users of the data access devices are, for example, relatives or classmates. The identification data may be in the form of a contact list, for example. Then, the process goes to step S42.

In step S42, the user at the terminal device sets the transmission authority of the data access devices through the setting module of the digital content processing system. Then, the process goes to step S43.

In step S43, the data access device that has sent a connection request through the network system is authenticated, and, if the data access device passes the authentication, the process goes to step S44; otherwise, the process goes to step S46.

In step S44, after the data access device that has sent the connection request passes the authentication, a web page operation interface corresponding to the identification data of the data access device is provided and transmitted to the data access device. Then, the process goes to step S45. The content of the web page operation interface comprises information pertaining to digital content sharing members and digital content transmission options, wherein the digital content sharing members are the data access devices or digital content supplier that establish digital content sharing relationship with the data access device that passes the authentication. Through the web page operation interface, a user can determine a destination for the digital content upload or a source for the digital content download according to the digital content sharing information, such as a contact list. Through the digital content transmission options, the user of the data access device can freely choose a digital content accessing method, for example, digital content download or upload.

In step S45, the digital content processing system performs corresponding processes according to information received by the web page operation interface. That is, the digital content processing system uploads the digital content stored in the data access device that passes the authentication to all, a portion of, or one of the data access devices having the digital content sharing relationship with the data access device, or downloads the digital content from all, a portion of, or one of the devices having the digital content sharing relationship with the data access device.

In step S46, the digital content processing system notifies the data access device that does not pass the authentication that the sharing of digital content cannot be provided.

Therefore, the digital content processing system and method of the present invention provide a solution to easy sharing of digital content, by allowing a user unfamiliar with the operation of computers and/or networks to conveniently share digital content over a network. Further, the instant messaging mechanism ensures real-time sharing of the digital content.

The above-described descriptions of the detailed embodiments are provided to illustrate the preferred implementation according to the present invention, and are not intended to limit the scope of the present invention. Accordingly, various modifications and variations completed by those with ordinary skill in the art fall within the scope of present invention as defined by the appended claims.

What is claimed is:

1. A digital content processing system to which at least a data access device can be connected through a communication network for accessing digital content, the digital content processing system comprising:
a setting module for setting identification data and transmission authority of the data access device;
an authentication module for authenticating the data access device according to the identification data of the setting module after the data access device sends a connection request through the communication network; and
a processing module for enabling the data access device to download digital content and/or upload digital content of the data access device according to the transmission authority of the data access device if the data access device passes the authentication of the authentication module.

2. The system of claim 1, wherein the setting of the transmission authority refers to setting of a download path for the data access device to perform the digital content download and/or setting of an upload path for the data access device to perform the digital content upload.

3. The system of claim 2, further comprising an editing module for editing a web page operation interface corresponding to the identification data of the data access device, wherein, after the data access device passes the authentication of the authentication module, the processing module provides the web page operation interface to the data access device such that a user of the data access device can freely choose a digital content accessing method according to options provided by the web page operation interface.

4. The system of claim 3, wherein, if there is a plurality of data access devices, the editing module is used to edit digital content transmission paths between the plurality of data access devices and provide information about digital content sharing members on the web page operation interface, in which the digital content sharing members are those of the data access devices that establish digital content sharing relationships with the data access device that passes the authentication, wherein, through the web page operation interface, a user can determine a destination for the digital content upload or a source for the digital content download according to the digital content sharing information.

5. The system of claim 3, wherein the data access device downloads the digital content from a digital content supplier and/or uploads the digital content thereof to the digital content supplier.

6. The system of claim 5, wherein, if there is a plurality of data access devices, the editing module is used to edit digital content transmission paths between the plurality of data access devices and provide information about digital content sharing member on the web page operation interface, in which the digital content sharing members are the data access devices or digital content supplier that establish digital content sharing relationships with the data access device that passes the authentication, wherein, through the web page operation interface, a user can determine a destination for the digital content upload or a source for the digital content download according to the digital content sharing information.

7. The system of claim 5, wherein the digital content supplier is integrated with the digital content processing system.

8. The system of claim 1, further comprising a notification module, wherein, when the data access device that passes the authentication completes the digital content upload, the notification module sends an instant message to notify a receiver of the digital content, or, when the data access device that passes the authentication completes the digital content download, the notification module sends an instant message to notify the supplier of the digital content.

9. A digital content processing method that allows at least a data access device to connect to a digital content processing system through a communication network so as to access digital content, the digital content processing method comprising the steps of:
(1) setting identification data and transmission authority of the data access device in the digital content processing system;
(2) authenticating the data access device by the digital content processing system according to the identification data when the digital content processing system receives a connection request of the data access device through the communication network; and
(3) enabling the data access device to, under control of the digital content processing system, download digital content and/or upload digital content of the data access device according to the transmission authority of the data access device if the data access device passes the authentication.

10. The method of claim 9, wherein the setting of the transmission authority refers to setting of a download path for the data access device to perform the digital content download and/or setting of an upload path for the data access device to perform the digital content upload.

11. The method of claim 9, wherein the step (1) further comprises step (1-1) of storing a web page operation interface corresponding to the identification data of the data access device such that, after the data access device passes the authentication, the digital content processing system provides the web page operation interface to the data access device, thereby allowing a user of the data access device to freely choose a digital content accessing method according to options provided by the web page operation interface.

12. The method of claim 11, wherein, if there is a plurality of data access devices, the step (1-1) further comprises editing digital content transmission paths between the plurality of data access devices and providing information about digital content sharing members on the web page operation interface, in which the digital content sharing members are those of the data access devices that establish digital content sharing relationships with the data access device that passes the authentication, wherein, through the web page operation interface, a user can determine a destination for the digital content upload or a source for the digital content download according to the digital content sharing information.

13. The method of claim 9 further comprising step (4): sending an instant message by the digital content processing system to notify a receiver of the digital content when the data access device that passes the authentication completes the digital content upload, or sending an instant message by the digital content processing system to notify the supplier of the digital content when the data access device that passes the authentication completes the digital content download.

14. The method of claim 9, wherein the data access device downloads the digital content from a digital content supplier and/or uploads the digital content thereof to the digital content supplier.

15. The method of claim 14, wherein the step (1) further comprises step (1-1) of storing a web page operation interface corresponding to the identification data of the data access device, and, in the case that there is a plurality of data access devices, the step (1-1) further comprises editing digital content transmission paths between the plurality of data access devices and providing information about digital content sharing members on the web page operation interface, in which the digital content sharing members are the data access devices or the digital content supplier that establish digital content sharing relationships with the data access device that passes the authentication, wherein, through the web page operation interface, a user can determine a destination for the digital content upload or a source for the digital content download according to the digital content sharing information.

16. The method of claim 14, wherein the digital content supplier is integrated with the digital content processing system.
